(19) United States
(12) Patent Application Publication
(10) Pub. No.: US 2006/0204699 A1
(43) Pub. Date: Sep. 14, 2006

(54) Parylene coated microfluidic components and methods for fabrication thereof

(76) Inventors: George Maltezos, Fort Salonga, NY (US); Hongxing Tang, Pasadena, CA (US); Michael Roukes, Pasadena, CA (US); Axel Scherer, Laguna Beach, CA (US)

Correspondence Address: Alessandro Steinfl, ESQ.;c/o LADAS & PARRY, Suite 2100, 5670 Wilshire Boulevard, Los Angeles, CA, 90036-5679, US

(21) Appl. No.: 11/297,124

(22) Filed: Dec. 7, 2005

Related U.S. Application Data
(60) Provisional application No. 60/634,667, filed on Dec. 8, 2004.
(60) Provisional application No. 60/634,668, filed on Dec. 8, 2004.

(51) Int. Cl. B29C 33/40; B29C 33/76; B28B 7/38; F16L 11/04

(52) U.S. Cl. 428/36.91; 264/221; 264/317; 264/338; 427/133

(57) ABSTRACT

A method for fabricating parylene coated microfluidic valves is disclosed. A three-dimensional mold made of a first wax is formed. A sacrificial material made of a second wax is provided as a temporary support and then dissolved. A parylene coating is deposited onto the mold. A component material is poured onto the mold and cured, and the first wax is melted away. Further, a method for parylene coating of two-dimensional microfluidic components comprises: forming a lithographic mold of a microfluidic component, the mold made of a photoresist material; coating the lithographic mold with parylene; and removing the lithographic mold.

### CROSS REFERENCE TO RELATED APPLICATIONS

The present application claims the benefit of provisional application 60/634,668 for “Replication Molding of Three-Dimensional Valves” filed on Dec. 8, 2004 and provisional application 60/634,667 for “On-Chip Refrigerator and Heat Exchanger” filed on Dec. 8, 2004, both of which are incorporated herein by reference in their entirety. The present application is also related to U.S. application Ser. No. ______ (Attorney Docket No. 622900-0) for “Thermal Management Techniques, Apparatus and Methods for Use in Microfluidic Devices” and to U.S. applicaiton Ser. No. ______ (Attorney Docket No. 622899-9) for “Prototyping Methods and Devices for Microfluidic Components,” filed on the same date of the present application, also incorporated herein by reference in their entirety.

### FEDERAL SUPPORT

This invention was made with U.S. Government support under contract No. R01 H6002644 awarded by the National Institute of Health. The U.S. Government has certain rights in this invention.

### BACKGROUND

1. Field

The present disclosure relates to microfluidic devices, such as valves. In particular, it relates to parylene coated microfluidic components and methods for fabrication thereof.

2. Related Art

Recently, lithographic techniques have been successfully applied towards the miniaturization of fluidic elements, such as valves, pumps and limited three dimensional structures (see references 1-10). The integration of many devices on a single fluidic chip has enabled the development of powerful and flexible analysis systems with applications ranging from cell sorting to protein synthesis. Through replication molding and embossing from photolithographically patterned dies, inexpensive fluidic systems with pneumatic actuation have been developed, by several groups (see references 11-19). Hermetically sealed valves, pumps and flow channels can be formed in polydimethylsilicone (PDMS) and related compounds (RTV, etc.), and in multilayer soft lithography, two or more replication molded layers are aligned and subsequently bonded to create systems of pneumatic actuation channels controlling flow within a layer of flow channels.

For example, two-dimensional valves are disclosed in U.S. Pat. No. 6,929,030 to Unger et al., which is incorporated herein by reference in its entirety. The valves disclosed in Unger are called two-dimensional because they are an extrusion of a two-dimensional drawing. In particular, in Unger, a structure is obtained where a first two-dimensional layer is put on top of a second two-dimensional layer. The two layers are then bonded together. After that, one of the two layers is pressurized to push on the other. No fluid flows between these two layers.

As the geometry of the pneumatic valve determines the actuation pressure, it is possible to define pneumatic multiplexing geometries that permit the control of many valves on a microfluidic chip by a much smaller number of control valves off-chip (see reference 20). Unfortunately, the two-dimensional nature of the flow channel arrangement limits the interconnection of this kind of two-dimensional fluidic system. Moreover, multi-layer soft lithography requires the use of elastomeric materials that can bond well to each other to avoid delamination of the pneumatic film layer from the fluid flow layer.

### SUMMARY

According to a first aspect, a printing method to fabricate a three-dimensional microfluidic component is disclosed, comprising: forming a three-dimensional mold of the three-dimensional microfluidic component, the mold made of a first wax; providing a sacrificial material acting as a temporary support, the sacrificial material made of a second wax; dissolving the second wax; depositing parylene coating on the mold; pouring a component material onto the mold; curing the poured component material; and melting away the first wax.

According to a second aspect, a method for parylene coating of two-dimensional microfluidic components is disclosed, comprising: a) forming a lithographic mold of a microfluidic component, the mold made of a photoresist material; b) coating the lithographic mold with parylene; and c) removing the lithographic mold.

According to a third aspect, a microfluidic channel is provided, the microfluidic channel comprising an inner core and an outer core, the inner core made of parylene, the outer core made of a component material.

According to a fourth aspect, a parylene coated three-dimensional microfluidic network is disclosed, comprising: parylene coated microfluidic flow tubes; parylene coated pressure chambers surrounding the microfluidic flow tubes; and vias connecting the microfluidic flow tubes.

The structures disclosed in accordance with the present disclosure are truly three-dimensional, in the sense that both the control and fluid lines can be built in the same fabrication step, without need to bond them together. In a structure like the one shown in the present disclosure, separate control and fluid lines having different geometries can be built, together with vias or chambers encircling a channel.

Three-dimensional connections between fluidic layers offer more flexible design opportunities that are inaccessible with planar techniques.

The methods in accordance with the present disclosure allow to construct fluidic conduits that require structural supports only every few centimeters, as well as robust, tunable, three-dimensional valves which can control flow pressures of over 220 kilopascals (33 psi).

The three-dimensional replication-molded microfluidic design is also insensitive to swelling caused by aggressive solvents.

Three-dimensional soft lithography offers many advantages over the more conventional multi-layer soft lithography, which is based on two-dimensional valve and pump definition. One key advantage of developing devices from three-dimensional replication molding is that it enables the use of a wide variety of elastomers and plastics that are more resistant to strong acids, bases and organic solvents. Moreover, the pressure in the flow channels can be increased and the actuation pressure of the pneumatic lines can be decreased by implementing designs that do not involve layers that may delaminate and can close the valve by applying pneumatic pressure from all sides.

An opportunity obtained from three-dimensional definition is the increase in inter-connectivity of the fluidic components and improvement in the flow channel integration in all three dimensions through the use of via holes that can jump over a fluidic layer or control layer with a commercially available wax molding system. A further opportunity is the ability to use fluorinated compounds. The first results obtained by applicants on this new kind of microfluidics indicate that denser integration with larger numbers of components and more complex fluidic multiplexing systems can be implemented through 3-D replication molding. Furthermore, the additional dimension allows the formation of larger diameter fluidic channels and enables fast flow and higher volume fluidic handling.

### BRIEF DESCRIPTION OF THE FIGURES

FIG. 1 is a flow chart of a method in accordance with a first embodiment of the present disclosure

FIG. 2 is a flow chart of a method in accordance with a second embodiment of the present disclosure.

FIG. 3 is a cross sectional view of an embodiment where a plastic clamp is used.

FIG. 4 shows a flow chart of a method in accordance with a third embodiment of the present disclosure.

FIG. 5 shows a flow chart of a method in accordance with a fourth embodiment of the present disclosure.

FIG. 6 shows a wax mold for a fluid line printed on a glass slide.

FIG. 7 shows a cross sectional view of the mold of FIG. 6.

FIG. 8 shows the structure of FIG. 7 after the build mold has been melted away and the three-dimensional “positive” structure has been created.

FIG. 9 shows a perspective view of a valve fabricated in accordance with the present disclosure.

FIG. 10 shows graphs indicating flow rate vs. valve actuating pressure for different flow pressures. The valve enters a tunable region in which the flow pressure is strongly affected by the actuating pressure. Toward the right of the graph a region of cutoff is entered, with leak-tight flow of less than 0.1 ml over 1 hour of testing.

FIG. 11 shows a micrograph of a wax mold before and after PDMS replication molding showing the geometry of the flow channels and the pneumatic actuation valves for a 36 valve, 16 to 1 fluidic multiplexer. The entire chip is made entirely of PDMS without the need for bonding to glass, and pressure inputs are made via steel pins on both sides (only the top side shown).

FIG. 12 is a schematic sectional view showing a microfluidic via connecting microfluidic channels.

### DETAILED DESCRIPTION

To solve the limitations of two-dimensional layered systems and to enable more flexible microfluidic plumbing topologies, the present application discloses a three-dimensional replication molding method that permits the construction of valves and pumps that are interconnected in all dimensions. To create three-dimensional replication dies, a commercial wax printing system can be used (e.g., Solidscape T66). The Solidscape T66 is a rapid protype machine (RPM) which can define features as small as 12.5 microns high by 115 microns wide. The person skilled in the art will understand that wax printing systems different from the Solidscape T66 machine or other rapid prototyping technologies (such as those producing a positive directly from light curable polymers like PFPE) can be used, so long as they allow microscale features to be obtained. Microfluidic components usually have a radius in the 10-500 microns range, preferably a 10-115 microns range, and most preferably a 10-100 microns range. The person skilled in the art will be able to select the adequate dimensions in order to allow the components to be integrated on a chip.

The combination of printed wax droplets with precise milling heads and stage positioning enables wax molds to be constructed with feature sizes comparable to those made by photolithography. The wax mold can be computer designed and printed directly onto a flat substrate without the need for any photolithography masks. The designer can fabricate three-dimensional microfluidic components interconnected with great flexibility.

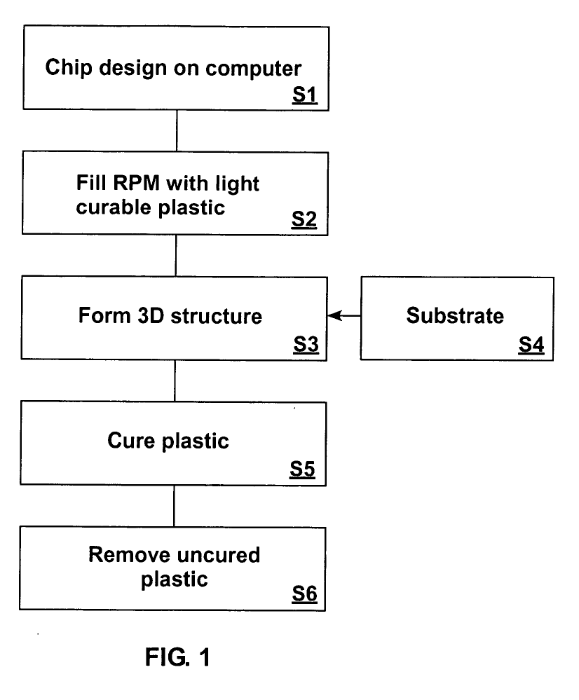

According to a first embodiment, also shown in FIG. 1, a chip is initially designed on a computer (S1) and the RPM is filled with light curable plastic (S2). Light curable plastic can be any type of plastic or wax suitable for microfluidics. For example, PFPE, curable (i.e. able to be shaped) by exposition to UV light. The RPM machine will allow a three-dimensional structure of a desired three-dimensional microfluidic component to be obtained (S3). If desired, the three-dimensional structure can be formed on a substrate (S4). The light plastic is cured (S5) during exposition to UV light, and the uncured plastic is removed (S6), for example by washing. The person skilled in the art will note that no molds are needed in this first embodiment, in the sense that a “positive” version of the desired three-dimensional structure is obtained without need of providing a prior “negative.”

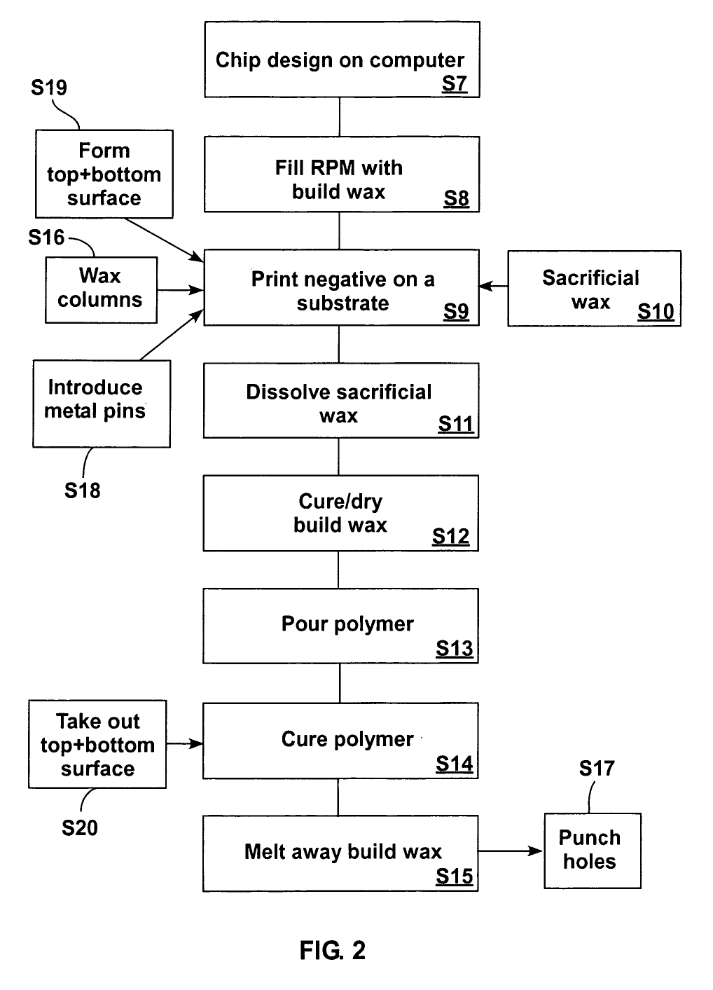

According to a second embodiment, also shown in FIG. 2, a “negative” mold is provided, and sacrificial or support wax is used. A chip is initially designed (S7) and the RPM is filled with a build wax (S8). A negative of the desired structure is then printed on top of a substrate (S9). Printing of the desired microchannels is usually performed by way of layer-by-layer processing, as typical with RPM machines. The substrate is preferably flat and can be made of glass or silicon wafer. Presence of a substrate allows a precise separation of the various components of the microfluidic chip and better bonding properties. In particular, a substrate provides a reference point for the structure to be formed and a smooth surface to mold upon.

During the printing process, also a sacrificial or support wax is provided, (S10) to temporarily support the desired, suspended structure during fabrication. The sacrificial or support wax is dissolved (S11) at the end of the fabrication process. If necessary, the fabricated build wax mold can be cured or dried (S12) by using, for example, air or an oven.

A subsequent step is that of pouring a polymer (S13) onto the mold. The polymer will form the “positive” of the structure, and can be a material such as PDMS (polydimethylsiloxane), PFPE (perfluoropolyether), SIFEL® (a fluorocarbon siloxane rubber precursor by Shin Etsu Chemical Co., Ltd) or parylene (a coating material). After pouring of the polymer, vacuum can be formed in the structure to better insert the polymer into the structure and to remove air out of the structure. The polymer is then cured (by heat, light etc.) and solidified (S14). The build wax mold (“negative”) is then melted away (S15) to provide the desired microfluidic device geometry.

In accordance with the present disclosure, holes in the wax mold can be created for the introduction of steel pins to connect input or output tubing. The steel pins can be melted to the wax, glued or attached by slip fit.

According to a first embodiment, wax columns (i.e. negatives of a hole) can be formed in the build wax during the printing process of the negative (S16). The polymer will then be poured so that a portion of the wax column remains out of the polymer. In this way, when the build wax is melted away, holes will be formed.

According to a second embodiment, holes can be formed through punching (S17) in the final polymer chip.

According to a third embodiment, metal pins can be introduced or soldered into the build wax mold (S18), and later pouring the polymer over the build wax mold by leaving part of the pin above the top level of the polymer. After that, once the wax has been melted, the pin is pulled out. Typically, the wax mold will be constructed with areas specifically made to have the pins soldered in. The pins can be melted to the specifically made areas, glued or attached by slip fit.

A variation of this embodiment can also be provided, where the structure does not depend on glass in order to allow precise separation of the various components of the microfluidic chip. According to this embodiment, during formation of the mold, two additional build surfaces, a top surface and a bottom surface, are formed (S19). Reference can be made, for example, to surfaces 70 and 80 of FIG. 10, described below. Later, during the curing process of the polymer, the two surfaces are taken out (S20). Further, during the melting process of one or both surfaces, a cut is made in the top and/or bottom surface, to allow separation of the holes.

As mentioned above, one type of polymer that can be used is SIFEL®. SIFEL® is a liquid fluoroelastomer (fluorocarbon siloxane rubber precursor) that combines the characteristics of silicone and fluorine and softens into a rubbery texture when heated. Two types of SIFEL®—glue and non-glue—are commercially available. Punching of SIFEL® to form holes is not possible. Therefore, a possible way of forming holes in this embodiment is that of forming them in the build wax mold, as described above. Alternatively, a metal pin of a smaller diameter of the pin to be later used for fluid introduction can be soldered. In order to do so, a solder point is designed and later formed in the build wax mold. SIFEL® is then poured from the top, in order to avoid its formation in the solder point. Presence of pin holes in an embodiment where glue-type SIFEL® is used is preferred, because glue-type SIFEL® will become attached to the glass support, thus precluding an exit way for the build wax upon dissolution. In this case, the build wax will come out through the pin holes. On the other hand, in case of non-glue-type SIFEL®, the build wax filled with SIFEL® can be detached from the substrate, and then taken out of the bottom of the structure.

Use of a PFPE polymer is similar to use of non-glue type SIFEL®. It should also be noted that both SIFEL® and PFPE usually cannot be bonded well to glass. In order to overcome this obstacle, a plastic clamp is machined, to allow for the pins or steel pins to protrude. Pressure is then applied to seal the glass to the polymer through the plastic clamp. The person skilled in the art will understand that the amount of pressure to be applied should be such that the polymer is sealed to the glass without crushing the microfluidic channels or valves formed in the structure.

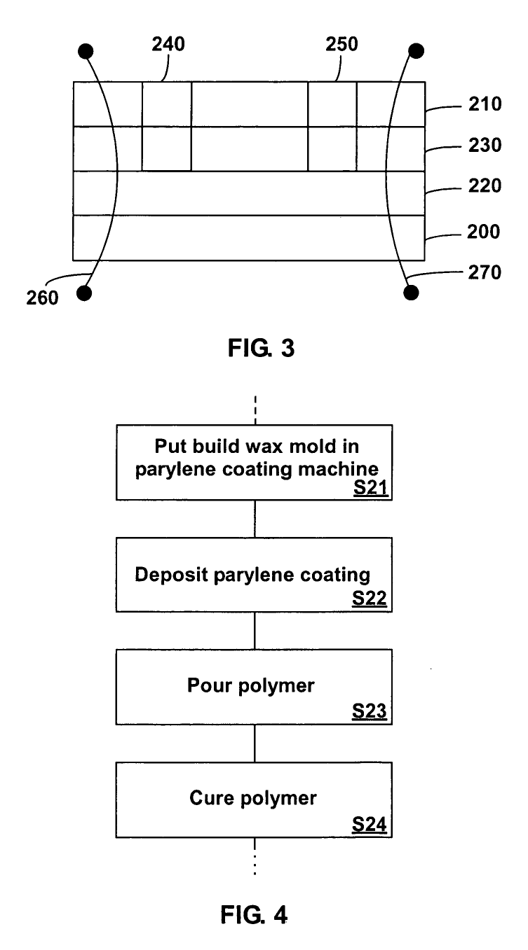

FIG. 3 shows a schematic cross-section of the structure in presence of the plastic clamp. In accordance with FIG. 3, plastic covers 200, 210 are disposed under substrate 220 and above polymer structure 230. Also shown in the figure are holes 240, 250 and screws 260, 270.

According to a further embodiment, as also shown in FIG. 4, a parylene coating can be applied. In particular, the same initial steps as shown in the second embodiment above can be applied, up to the polymer pouring step. Further to that, and before the polymer pouring step, the build wax mold is put into a parylene coating machine (e.g., machines made by Special Coating Systems) (S21) and a parylene coating is deposited (S22) by way of a conformal coating process. The thickness of the parylene coating can be of about 10 nm to 100 microns, for example about 2 microns. Following the parylene deposition step, a polymer (e.g., PDMS, PFPE, or SIFEL®) is put on top of the parylene coated build wax structure (S23). In biological or chemical analysis, chemical resistance is a desired material property. Parylene is stable in most strong acids, bases and organic solvents. Parylene is also a biocompatible material that is qualified as USP Class VI material that can be used in implant devices. In this way, a structure which is both chemically resistant (parylene coating) and physically strong (polymer) is obtained. Further, when parylene is applied to the methods and devices of the present disclosure, a quicker fabrication with finer features (down to 1-2 micron) can be obtained.

In order to provide the structure with pinholes, several choices can be made. According to a first choice, holes can be punched in the polymer chip—through both parylene and the polymer—after the build wax has been melted out, similarly to what shown in step S17 of FIG. 2. According to a second choice, wax columns can be formed as part of the wax mold, similarly to what shown in step S16 of FIG. 2. The polymer will then be poured so that a portion of the wax column remains out of the polymer. In this way, when the build wax is melted away, a hole will be formed. Additionally, a smaller hole is punched in the parylene on top of the column. Since the smaller hole is away from the fluid channel, any cracking will not affect the performance of the device. According to a third choice, holes can be formed through insertion of metal pins, similarly to the SIFEL® embodiment or similarly to what shown in step S18 of FIG. 2, before the parylene coating step. The polymer will then be poured leaving part of the pin above the top level of the polymer. After parylene has been coated and the polymer has been poured, a region will be cut around the pin to cut the parylene off the pin and open a way for the wax to come out through the pin. After that, the wax will be melt and the pin will be pulled out, thus forming holes in the structure. In accordance with this embodiment, the wax mold will be constructed with areas specifically made to have the pins soldered in.

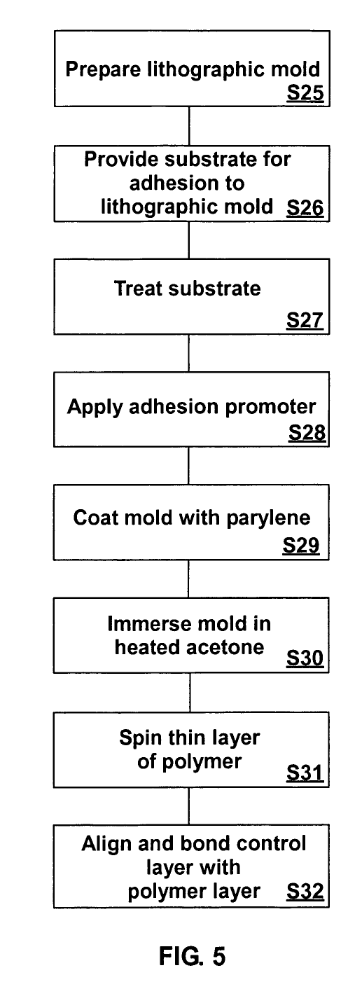

In accordance with a further embodiment, a method for parylene coating of two-dimensional microfluidic channels is disclosed, as also shown in FIG. 5. According to the embodiment, the microfluidic channels will comprise an inner core and an outer core, the inner core made of parylene, the outer core made of a component material.

In a first step a substrate is coated with a thin layer of parylene for better adhesion for the next lithographic molds (S26). In order to provide a clean surface, the substrate surface is first dipped in 5% HF (fluoridic acid) and then treated using oxygen plasma (S27). The oxygen plasma can be generated in a Technic® parallel plate reactive ion etcher (MicroRIE) with a 170 W RF power, 20 sccm O₂ flow rate, and a 30 s etching time. After plasma cleaning, an adhesion promoter (e.g., promoter A-174 from Specialty Coating Systems) can be applied (S28) to the surface to further enhance good adhesion between the parylene (see below)and the substrate. The substrate is then coated with a thin layer of parylene film of thickness between about 100 nm and about 2 micrometer. Coating promotes adhesion and provides passivation.

In a second step, a lithographic mold is formed (S25) in the same manner as described above and in FIG. 2, the only difference being that the mold is made of photoresist and not of wax. The photoresist is left “soft baked”, so that it may be later removed by soaking in acetone. Soft baking is also done to: 1) drive away the solvent from the spun-on resist; 2) improve the adhesion of the resist to the wafer; and 3) anneal the shear stresses introduced during the spin coating. Soft baking may be performed using one of several types of ovens (e.g., convention, IR, hot plate). The recommended temperature range for soft baking is between 90-100° C., while the exposure time is established based on the heating method used and the resulting properties of the soft-baked resist.

In a third step, the treated mold is conformally coated with a layer of parylene (S29).

In a fourth step, the mold is immersed in heated acetone (S30) to remove the sacrificial photoresist. The extremely thin parylene channels can be used as is. Such embodiment can be particularly useful for imaging what is inside the channels under an optical microscope or in an environmental SEM (scanning electron microscope), because the parylene is thin, so that a significant portion of the electron beam can penetrate the thin film and generate a scanning electron image.

Optionally, a thin layer of polymer (PDMS, PFPE or SIFEL®) is spinned over the parylene coated mold and cured (S31). The photoresist is then removed with heated acetone. In this way, a structurally robust channel is formed, still maintaining the structural properties of the polymer but protected from chemicals by the parylene.

Optionally, a control layer can be aligned and bonded with the polymer layer over the parylene coated channel in order to form a two-dimensional valve.

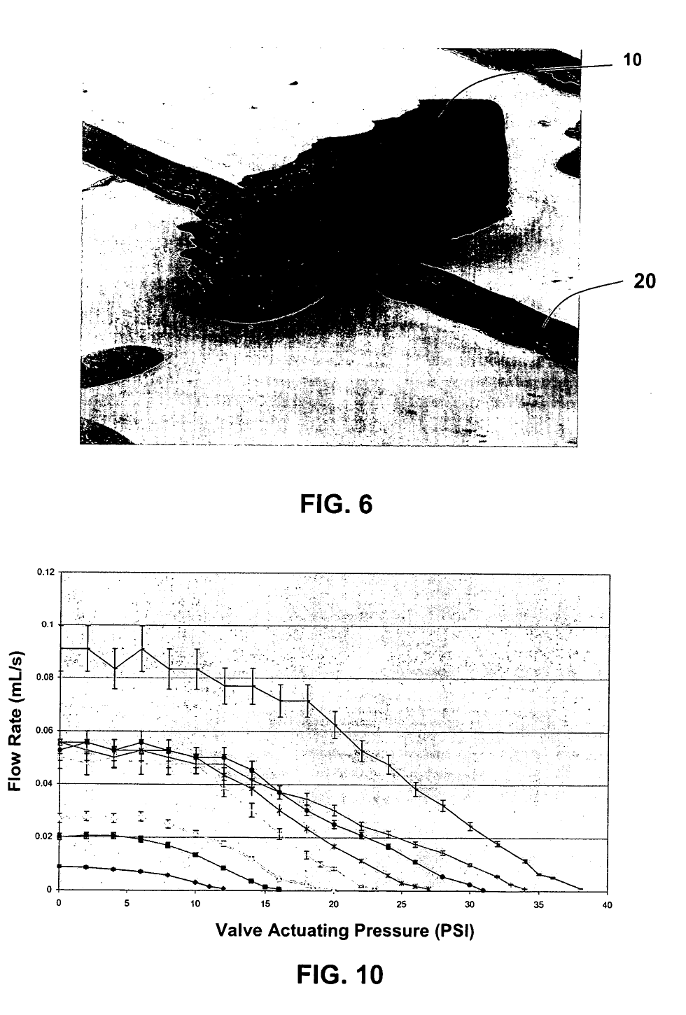

FIG. 6 is a SEM (scanning electron microscope) picture showing a 115 micron wide wax mold for a fluid line printed on a glass slide, where the negative of a control portion 10 and the negative of a microfluidic channel 20 are shown.

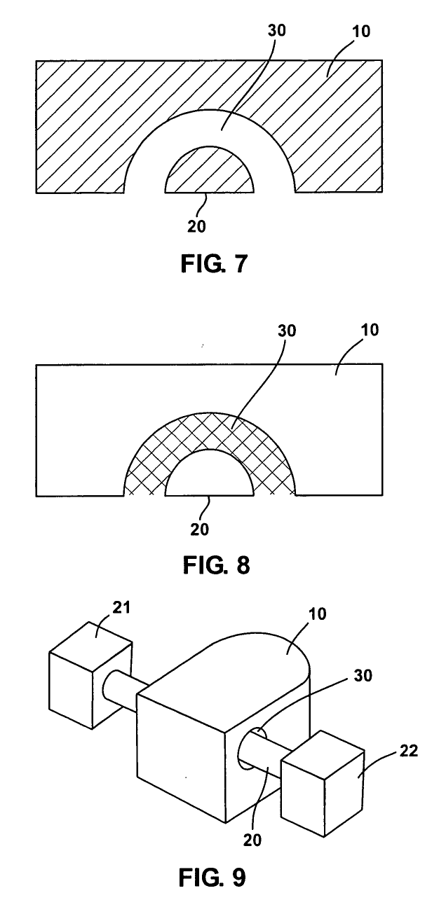

FIG. 7 shows a cross-sectional view of FIG. 6. Control portion 10 is separated by fluid portion 20 through an air channel 30. Both portions 10 and 20 are filled with build wax.

FIG. 8 shows the same structure of FIG. 7 after the build wax has been melted away. The structure obtained in FIG. 8 is the “positive” of the “negative” shown in FIG. 7. The inside of doughnut-shaped portion 10 contains air, the inside of portion 20 is adapted to contain the fluid to be controlled, and the inside of portion 30 is made of the cured polymer, for example PDMS. Portion 30 is the membrane that will allow/impede passage of fluid in channel 20 upon exerting/not exerting pressure on portion 10. Therefore, the valve is actuated by increasing the pressure in the doughnut chamber 10 surrounding the fluid flow tube 30 by a predictable amount dependent on the precise valve geometry.

In accordance with the teachings of the present disclosure, the valve shown in FIGS. 6, 7 and 8 is made with a single forming process, instead of having two different layers to be aligned and later bonded. FIG. 9 shows a perspective view of a negative of a valve obtained with the method in accordance with this disclosure, where portion 10 forms a chamber encircling channel 20. Also shown in the figure are terminal sections 21, 22 of the “negative” of channel 20.

FIG. 10 shows typical flow curves of a three-dimensional pneumatic valve constructed in PDMS. The flow rate is shown as a function of the actuating pressure of the pneumatic ring or cylinder for various flow pressures applied to the fluidic channel. From this data, it is evident that the 3-D valve in accordance with the present disclosure is able to perform even at relatively very high pressures of about 250 kPa (35 psi). At all tested pressures, the valve can be closed by applying a pneumatic pressure 62 kPa (9 psi) above the flow pressure applied to push fluids through the flow channel. The closing pressure depends on the valve geometry. In other words, the longer and/or thinner the cylinder, the lower the closing pressure.

The maximum pressure range as well as the control over the valve actuating pressure compares very favorably with traditional planar valves constructed through multi-layer soft lithography. In comparison, the multi-layer soft lithography layers in accordance with the present disclosure delaminate at approximately 82 kPa (12 psi). FIG. 10 also shows that the 3-D valve can be predictably tuned over a large range of flow rates by controlling the actuating pressure and initial flow pressure. The graph depicts a family of curves that represent a variety of different initial flow pressures. In general, three important regions can be observed: (a) toward the left part of the valve response plot, at low actuation pressures, a region is present within which the valve is unaffected by the actuating pressure. In this case, the flow pressure is significantly larger than the actuating pressure. As the actuating pressure becomes comparable to the flow pressure, (b) the valve enters a tunable region where the flow is linearly sensitive to actuation pressure. Finally, (c) the valve is pinched off when the difference between the actuating pressure and flow pressure reaches 62 kPa (9 psi). Flow rates were experimentally measured with a 10 ml graduated cylinder and a stopwatch. After the pneumatic valve actuator pressure was established, the fluid flow valve was opened and simultaneously a timer was used to measure flow rates. When 1.0 ml of fluid flowed through the valve and was accumulated in a collection reservoir, the time was measured and a flow rate was calculated. Measurements were conducted for several devices to confirm good reproducibility. Flow hysteresis was found to be negligible and did not influence the measurements as the valve was always closed at the beginning of each experiment.

The applicants have designed a three-dimensional normally open valve geometry. The pneumatic 3-D valve of the present disclosure was also tested in solvents that are known to deteriorate PDMS channels. For example, the valve performance was evaluated when metering toluene, a material known to result in swelling of PDMS and deterioration and distortion of conventional PDMS fluidic systems. As the 3-D valve definition procedure in accordance with the present disclosure does not rely on multi-layer PDMS films that could delaminate, no leakage or deterioration could be observed in the 3-D valve after exposure to toluene. Although the tenability suffered due to swelling over time, the valve performance was not influenced.

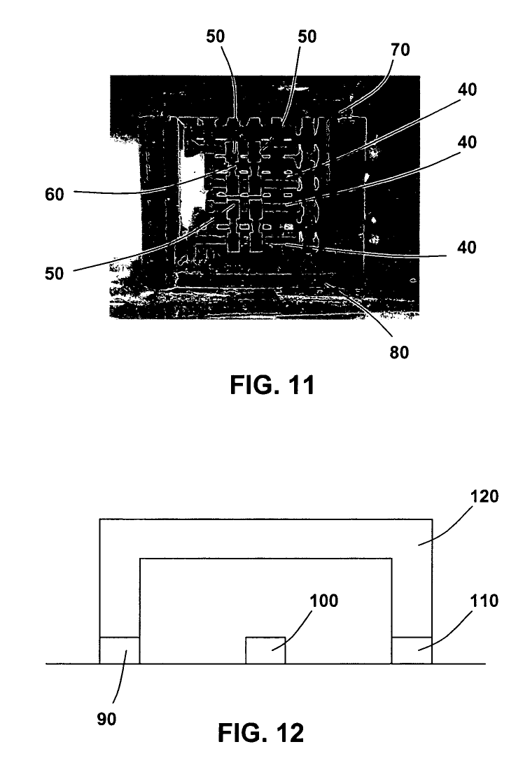

FIG. 11 shows an optical micrograph of a three dimensional multiplexer mold consisting of an integrated multiple layer array of 18 three-dimensional pneumatic valves. Similarly to what shown in FIG. 6, FIG. 11 is the “negative” of the final structure and shows the wax mold before the polymer pouring step. Shown in the figure is an array of microfluidic channels 40, control sections 50 encircling the channels 40 and vias 60. Also shown in the figure are a reference top surface 70 and a reference bottom surface 80.

As already mentioned above, the two surfaces 70 and 80 are taken out during the melting step. In addition, a further portion of the exposed top surface and the exposed bottom surface of the structure is cut, to allow separation of the microfluidic channels once the positive of the structure is obtained. Cutting of the further top and bottom portions will prevent undesired fluid contact among the various channels.

From this image, it is clear that large plumbing systems consisting of integrated arrays of microfluidic valves can be constructed by 3-D microvalve definition. In such a valve network, the density of fluidic elements can be significantly increased beyond what is available for more traditional 2-D microfluidic networks constructed from PDMS. In such 3-D fluidic chips, the smallest flow pressure line that can be defined by the lateral and vertical resolution of the wax printer is 115 microns wide by 12.5 microns high (although some difficult geometries require more material strength and must be made larger). These dimensions match well with geometries suitable for the definition of useful microfluidic “laboratory on a chip” applications.

Three-dimensional printing in accordance with the present disclosure eliminates the need for bonding the pneumatic control layer to the flow layer as both are formed in the same monolithic mold. This enables the use of elastomers that can be bonded only once or do not satisfy the adhesion requirements of multi-layer fabrication such as the highly solvent-resistant perfluoropolyether (PFPE) The elimination of multiple bonding steps also avoids the need for aligning multiple elastomeric layers and compensation for polymer shrinkage. Additionally, components can be embedded into the device in a three-dimensional fashion and pin input holes can be formed as part of the mold in situations where punching would crack brittle polymer layers. Solvent-resistant microfluidic components enable the use of organic solvents incompatible with polydimethylsiloxane (PDMS), thus opening up a vast array of potential microfluidics applications in organic chemistry and combinatorial synthesis.

The embedding of the components into the device works as follows: 1) The wax substrate is built up on the glass substrate; 2) When the mold reaches the layer where the embedded item (e.g. a filter) is to be placed, the machine is paused and the mold removed; 3) The item is melted to the wax with the use of a heater (similarly to a soldering iron) and made level with the last layer printed; 4) The mold is put back in the machine and it continues building. As the next layer is built, the deposited liquid wax is bonded to the embedded piece and becomes one with the mold; 5) The mold is processed as before, with the filter being embedded in the final polymer. This embedding process works similarly also with the parylene embodiment.

FIG. 12 shows an example of how vias in the structure of FIG. 11 can selectively connect microfluid channels. In particular, FIG. 12 is a partial cross section of a structure like the one shown in FIG. 11 where channels 90, 100, and 110 are shown, together with a microfluidic via or bridge 120. The via 120 allows channel 90 to be fluidically connected with channel 110. During formation of the mold, the via 120 will be a wax-filled bridge. Upon formation of the structure, the walls of the via 120 will be made of polymer and the inside will be void, to allow fluid transmission.

While several illustrative embodiments of the invention have been shown and described in the above description, numerous variations and alternative embodiments will occur to those skilled in the art. Such variations and alternative embodiments are contemplated, and can be made without departing from the scope of the invention as defined in the appended claims.

### LIST OF REFERENCES

[1] J. P. Brody and P. Yager, “Low Reynolds number microdevices”, In Proc. Of Solid State Sensor and Actuator Workshop, pp. 105-8. Hilton Head, June 1996.
[2] S. R. Quake and A. Scherer, “From Micro to Nano Fabrication with Soft Materials”, Science 290, 1536 (2000).
[3] H. P. Chou, M. A. Unger, A. Scherer and S. R. Quake, “A Microfabricated Rotary Pump”, Biomedical Microdevices 3, 323 (2001).
[4] J. Liu, M. Enzelberger, and S. R. Quake, “A nanoliter rotary device for PCR”, Electrophoresis, in press.
[5] Jeon N L, Chiu D T, Wargo C J, Wu H K, Choi I S, Anderson J R, Whitesides G M, “Design and fabrication of integrated passive valves and pumps for flexible polymer 3-dimensional microfluidic systems”, BIOMEDICAL MICRODEVICES 4 (2): 117-121 May 2002
[6] Dharmatilleke S. Henderson, H. T., Three-Dimensional Silicone Device Fabrication and Interconnection Scheme for Microfluidic Applications Using Sacrificial Wax Layers. Micro-Electro-Mech. Syst. 2000, 2, 413-418.
[7] Wu H K, Odom T W, Chiu D T, Whitesides G M, “Fabrication of complex three-dimensional microchannel systems in PDMS”, JOURNAL OF THE AMERICAN CHEMICAL SOCIETY 125 (2): 554-559 Jan. 15, 2003
[8] M. A. Unger, H. P. Chou, T. Thorsen, A. Scherer and S. R. Quake, “Monolithic Microfabricated Valves and Pumps by Multilayer Soft Lithography”, Science 288, 113 (2000).
[9] K. Ikuta, S. Maruo, Y. Fukaya, T. Fujisawa, “Biochemical IC chip toward cell free DNA protein synthesis”, MEMS 2000, Miyazaki, Japan, Jan. 23-27, 2000, pp. 131-136.
[10] K. Ikuta, T. Hasegawa, T. Adachi, S. Maruo, “Fluid drive chips containing multiple pumps and switching valves for Biochemical IC Family”, MEMS 1998, Heidelberg, Germany, Jan. 25-29, 1998, pp. 739-744.
[11] H. Morgan, N. G. Green, M. P. Hughes, W. Monaghan and T. C. Tan, “Large area traveling-wave dielectrophoresis particle separator”, J. Micromech. Microeng. 7, 65 (1997).
[12] S. Fiedler, S. G. Shirley, T. Schnelle, and G. Fuhr, “Dielectrophoretic sorting of particles and cells in a microsystem”, Anal. Chem. 70, 1909 (1998).
[13] M. U. Kopp, A. J. deMello, A. Manz, “Chemical amplification: continuous flow PCR on a chip”, Science 280, 1046 (1998).
[14] L. C. Waters, S. C. Jacobson, N. Kroutchinina, J. Khandurina, R. S. Foote and J. M. Ramsey, “Microchips devices for cell lysis, multiplex PCR amplification, and electrophoretic sizing”, Anal. Chem. 70, 158 (1998).
[15] P. H. Li and D. J. Harrison, “Transport, manipulation and reaction of biological cells on-chip using electrokinetic effect”, Anal. Chem. 69, 1564 (1997).
[16] A. G. Hadd, D. E. Raymond, J. W. Halliwell, S. C. Jacobson and J. M. Ramsey, “Microchip device for performing enzyme assays”, Anal. Chem. 69, 3407 (1997).
[17] A. G. Hadd, S. C. Jacobson and J. M. Ramsey, “Microfluidic assays of acetylcholinesterase inhibitors”, Anal. Chem. 71, 5206 (1999).
[18] N. H. Chiem and D. J. Harrison, “Microchip-based capillary electrophoresis for immunoassays: analysis of monoclonal antibodies and theophylline”, Electrophoresis 19, 3040 (1998).
[19] A. Y. Fu, C. Spence, A. Scherer, F. H. Arnold and S. R. Quake, “A microfabricated fluorescence-activated cell sorter”, Nature Biotech. 18, 309 (2000).
[20] T. Thorsen, S. J. Maerkl, S. R. Quake, “Microfluidic Large-Scale Integration”, Science 298, 5593 (2002).

What is claimed is:

1. A printing method to fabricate a three-dimensional microfluidic component, comprising:
forming a three-dimensional mold of the three-dimensional microfluidic component, the mold made of a first wax;
providing a sacrificial material acting as a temporary support, the sacrificial material made of a second wax;
dissolving the second wax;
depositing parylene coating on the mold;
pouring a component material onto the mold;
curing the poured component material; and
melting away the first wax.

2. The method of claim 1, wherein depositing a parylene coating is performed by way of a conformal coating process.

3. The method of claim 1, wherein the component material is chosen from the group consisting of PDMS, PFPE and SIFEL®.

4. The method of claim 1, further comprising punching holes in the fabricated three-dimensional microfluidic component.

5. The method of claim 1, wherein forming the three-dimensional mold comprises forming wax columns as part of the mold and wherein the component material is poured so that a portion of the wax columns remains out of the component material.

6. The method of claim 5, further comprising punching a hole in the parylene.

7. The method of claim 1, further comprising forming holes through insertion of metal pins.

8. The method of claim 1, further comprising providing a substrate precoated with a layer of parylene.

9. The method of claim 1, wherein the layer of parylene has a thickness between about 100 nm and about 2 micrometer.

10. A method for parylene coating of two-dimensional microfluidic components, comprising:
a) forming a lithographic mold of a microfluidic component, the mold made of a photoresist material;
b) coating the lithographic mold with parylene; and
c) removing the lithographic mold.

11. The method of claim 10, wherein the lithographic mold is removed by immersion in heated acetone.

12. The method of claim 10, further comprising:
providing a polymer layer over the parylene coated mold; and
removing the photoresist material with heated acetone.

13. The method of claim 10, wherein steps a)-c) are performed one time to form a first microfluidic component and another time to form a second microfluidic component.

14. The method of claim 13, wherein the second microfluidic component is put on top of the first microfluidic component, the first microfluid component forming a microfluidic channel and the second microfluidic component forming a microfluidic control section.

15. The method of claim 10, further comprising:
d) providing a substrate for adhesion to the lithographic mold; and
e) adhering the lithographic mold to the substrate.

16. The method of claim 15, wherein providing the substrate for adhesion to the lithographic mold comprises:
d1) dipping a substrate surface in 5% HF; and
d2) applying an adhesion promoter to the surface,
to allow adhesion of the parylene to the substrate.

17. The method of claim 16, wherein providing the substrate for adhesion to the lithographic mold further comprises:
d3) treating the surface with oxygen plasma.

18. The method of claim 15, further comprising precoating the substrate with a layer of parylene.

19. A microfluidic channel comprising an inner core and an outer core, the inner core made of parylene, the outer core made of a component material.

20. A parylene coated three-dimensional microfluidic network comprising:
parylene coated microfluidic flow tubes;
parylene coated pressure chambers surrounding the microfluidic flow tubes; and
vias connecting the microfluidic flow tubes.

21. The network of claim 20, wherein the network is made of a component material selected from the group consisting of plastic, an elastomer, a prepolymer, PDMS, PFPE and SIFEL®.

22. The network of claim 20, further comprising steel pins acting as pressure inputs.
